(19) United States
(12) Patent Application Publication
(10) Pub. No.: US 2009/0119987 A1
(43) Pub. Date: May 14, 2009

(54) Stackable nursery trays for plants

(76) Inventor: John Ingrassia, Staten Island, NY (US)

Correspondence Address: Aleksandr Smushkovich, POB 140505, Brooklyn, NY, 11214, US

(21) Appl. No.: 11/974,554

(22) Filed: Oct. 15, 2007

(51) Int. Cl. A01G 9/02

(52) U.S. Cl. 47/66.5; 47/83

(57) ABSTRACT

A simple and inexpensive nursery device is provided, comprising: at least two identical trays containing plant cells, identical bushings coupled to the trays so that each of the trays furnished with an equal number of the bushings identically disposed at corresponding predetermined points of the trays, and identical rods of a predetermined height. Bushings internally include upper and lower cavities, and partitions fixed therebetween. The rods are made insertable into the cavities, being supported by the partitions. The trays can be assembled in stack by making one tray a lower tray, inserting the rods into the lower tray's upper cavities, inserting the rods into the lower cavities of the corresponding bushings of another tray, thereby making it an upper tray. Embodiments include different bushings dispositions on the trays, combined rods assembled of component rods. Some rods include threaded top holes and threaded bottom heads, some bushings cavities include fixation threadings.

### FIELD OF THE INVENTION

The invention relates to devices usable for growing plants, such as flowers, vegetables, etc. More specifically, it relates to nursery trays, mostly containing cells, which cells are used for growing plants, though may find other useful applications.

### BACKGROUND OF THE INVENTION

There are known several constructions of trays for plants in the prior art. One of the typical problems with utilizing such trays is limited space where the trays are located. A common solution to the problem is arranging the trays in stacks, i.e. above each other.

One such example is described in U.S. Pat. No. 5,040,328: “A mushroom tray comprising a tray portion having opposing sidewalls, opposing end walls and a substantially flat bottom sheet having a parallity of channels formed therein and extending therealong, corrosion-resistant I-beams positioned within the channels for strengthening and stiffening the bottom sheet, and a parallity of clips for securing the I-beams to the underside of the bottom sheet. In a preferred embodiment, the trays include downwardly projecting legs which are shaped enable the trays to be stacked vertically.”

U.S. Pat. No. 5,930,951 describes “A modular, threaded container for growing plants and subsequently increasing size of the container. Modules are arranged to be stacked on one another to increase overall height of the modular assembly. Individual modules include a top module having bottom threading only, intermediate modules open at the top and bottom and having top and bottom threading, and a bottom module having a floor and threading at the top only. The container may optionally include frustoconical modules, a first frustoconical bottom module configured to replace an open intermediate module with a module closed at the bottom, and a second frustoconical module closed at the bottom of dimensions and configuration different from those of the first bottom module. The plant is grown in a container having relatively few modules. After growth has occurred, the bottom module is removed and an intermediate module open at both ends is filled with growing medium and is inserted in series prior to replacing the bottom module. Alternatively, a different bottom module is employed.”

Another U.S. Pat. No. 6,029,399 teaches “Vertically stackable benches and pallets for holding three inch and four inch diameter planting pots, wherein the benches can be entirely formed from wire. Each of the benches has a center portion formed from a planar shaped wire grid. Support members on opposite ends of the wire grid allow the benches to be stacked on top of one another while maintaining an airspace therebetween. Each support member has an upper bent tip extending upwardly from the surface of the grid, and a lower legs that form a downwardly opening slot opening, the legs extending below the undersurface of the grid. The bent tips of a first bench interlock into the slot in the legs of a second bench that is stacked on top of the first bench. Airspaces between each of the stacked pallets allows for seedlings in the pots to grow regardless of whether the pots are arranged in every grid opening or in staggered grid openings.”

Yet, U.S. Pat. No. 6,237,286 discloses “. . . an improved nursery tray and apparatus for handling such a nursery tray during propagating and growing periods, the tray (10) comprising a plurality of cells (18) in a predetermined array having two opposed side walls (14, 15) and two opposed end walls (16, 17), the tray being characterized by a plurality of spaced slots (28) located in opposed walls (14, 15, 16, 17) with each slot (28) being aligned with a space between two of said cells (18) and each slot (28) having an open end at a lower edge of the walls (14, 15, 16, 17) in which the slots are formed, the apparatus for handling such trays being characterized by support members (40) interconnected by chains (46) into an endless configuration capable of being driven by drive means (42) such that the support members move along guideways (41), the support members (40) each having at least one elevated tray engagement part (45) configured to engage in tray edge formations such as the slots (28) to support the trays in a manner preventing obstruction of their lower faces.”

All the aforementioned constructions and many others include complicated structures and elements, and hence are expensive and difficult to use. The purpose of the present invention is to provide simple and effectively usable constructions for plant nursery trays that allow for easy storage, access, and transportation of the trays, and, on the other hand, save space for placement of the trays in nursery facilities, stores, etc.

### BRIEF DESCRIPTION OF THE INVENTION

The present invention provides the following useful and novel features: it permits vertically stacking the nursery trays in an easy manner above each other in the storage or transportation position, allows for easy access to the cells contained in the trays and for safe growing the plants in the cells, and saves the plants during transportation due to arranging a predetermined vertical space between upper and lower trays.

The invention enables to quickly and simply assemble the trays into stacks, and dissemble them when needed. The inventive trays and means of their attachment can be merely made of suitable widely used materials applying known inexpensive technologies. The trays thus can be cheap and convenient for producers and users.

In a preferred embodiment, an inventive nursery device comprises a tray made in a shape of rectangular parallelepiped without the topside, containing rectangular cells with growing plants. It includes a bottom and four preferably vertical sidewalls fixed to the bottom. If necessary, special embodiments may have non-vertical sidewalls, or even no sidewalls, or may have trays of a non-rectangular shape.

The inventive device comprises preferably four cylindrical bushings attached in predetermined identically disposed points on the outer surface of two mutually opposite sidewalls. In other embodiments, there can be different numbers of bushings, and they can be attached not necessarily to two sidewalls (e.g. to three or four sidewalls of the tray). In some embodiments, bushings can be arranged inside the tray, and coupled, for instance, to its bottom.

One of the aims of the inventive device is to make it simple for production. In order to provide simple manufacture of the trays, they should be designed uniformly, i.e. there should be no difference between a lower tray and an upper tray stacked above the lower tray.

This is achieved by special designing the bushings. Each bushing is divided into an upper cavity and a lower cavity, both having a cylindrical shape. The dividing is provided by a flat circular partition (or alternatively, by a ring-shaped shelf) fixed preferably in the middle of the bushing interior. Therefore, the upper cavity is formed with the inner sidewalls of the bushing upward from the partition, whereas, the lower cavity is formed with the inner sidewalls of the bushing downward from the partition.

The inventive device comprises cylindrical rods removably snug-fitting into the cavities of the bushings. The rods are preferably made identical, so that any rod can be used in place of another rod, which continues the uniformity of the bushings. Such uniformity enables interchangeability, and reduces expenses of the manufacturers, contributing to a decrease of price of the final product. In other embodiments, the bushings and rods may have a shape different from cylindrical, or may have additional conventional fasten means, fixing the rods inside the bushings.

### BRIEF DESCRIPTION OF THE DRAWINGS

FIG. 1 illustrates an isometric view of an inventive device in a dissembled state, according to an exemplary embodiment of the present invention.

FIG. 2 illustrates an isometric view of the inventive device in an assembled state, according to the exemplary embodiment shown on FIG. 1.

FIG. 3 illustrates a partial isometric view of the inventive device, externally showing bushings attached to two trays positioned one above the other, and rods connecting the trays, according to the exemplary embodiment shown on FIG. 1.

FIG. 4 illustrates a partial isometric view of the inventive device, internally showing a bushing attached to the tray, showing a rod inside the bushing and another rod outside the bushing, and separately depicting a sectional quarter of the bushing, according to the exemplary embodiment shown on FIG. 1.

FIG. 5 illustrates a partial isometric view of the inventive device, internally showing a bushing with screw threading, showing a rod with screw threading situated inside the bushing, a rod with screw threading situated outside the bushing, and separately depicting a sectional quarter of the bushing, according to another exemplary embodiment of the present invention.

FIG. 6 illustrates a partial isometric view of the inventive device, externally showing bushings attached to two trays positioned one above the other, and rods connecting the trays, wherein the bushings are disposed close to a corner of the tray; according to another exemplary embodiment of the present invention.

FIG. 7 illustrates a partial isometric view of the inventive device, internally showing a bushing attached to the tray, showing a rod inside the bushing and another rod outside the bushing, and separately depicting a sectional quarter of the bushing, according to the exemplary embodiment shown on FIG. 6.

FIG. 8 illustrates a partial isometric view of the inventive device, externally showing bushings attached to two trays positioned one above the other, and rods connecting the trays, wherein the bushings are disposed at a corner of the tray, according to another exemplary embodiment of the present invention.

FIG. 9 illustrates a partial isometric view of the inventive device, internally showing a bushing attached to the tray, showing a rod inside the bushing and another rod outside the bushing, and separately depicting a sectional quarter of the bushing, according to the exemplary embodiment shown on FIG. 8.

Identical reference numerals in the drawings generally refer to the same elements in different figures. A first-time introduced numeral in the description is enclosed into parentheses.

### DESCRIPTION OF EXEMPLARY EMBODIMENTS OF THE INVENTION

While the invention may be susceptible to embodiment in different forms, there are shown in the drawings, and will be described in detail herein, specific exemplary embodiments of the present invention, with the understanding that the present disclosure is to be considered an exemplification of the principles of the invention, and is not intended to limit the invention to that as illustrated and described herein.

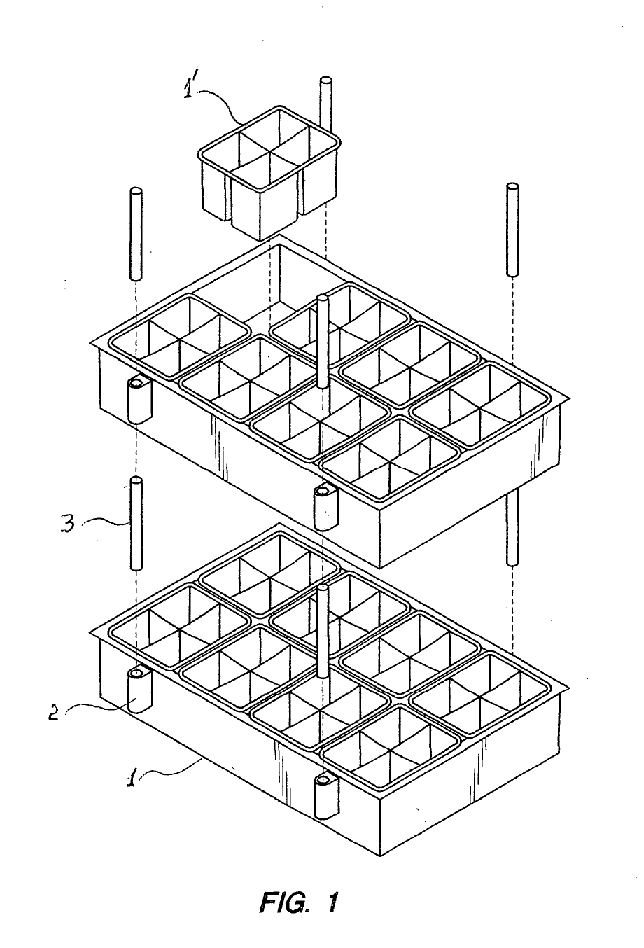

A preferred embodiment of the inventive device in a dissembled state is illustrated on FIG. 1, and comprises at least two identical trays (1), each made in a rectangular shape, and each containing a plurality of rectangular cells, such as a cell (1′) depicted separately, wherein growing plants can be placed. Each tray 1 includes a bottom and four vertical sidewalls fixed to the bottom.

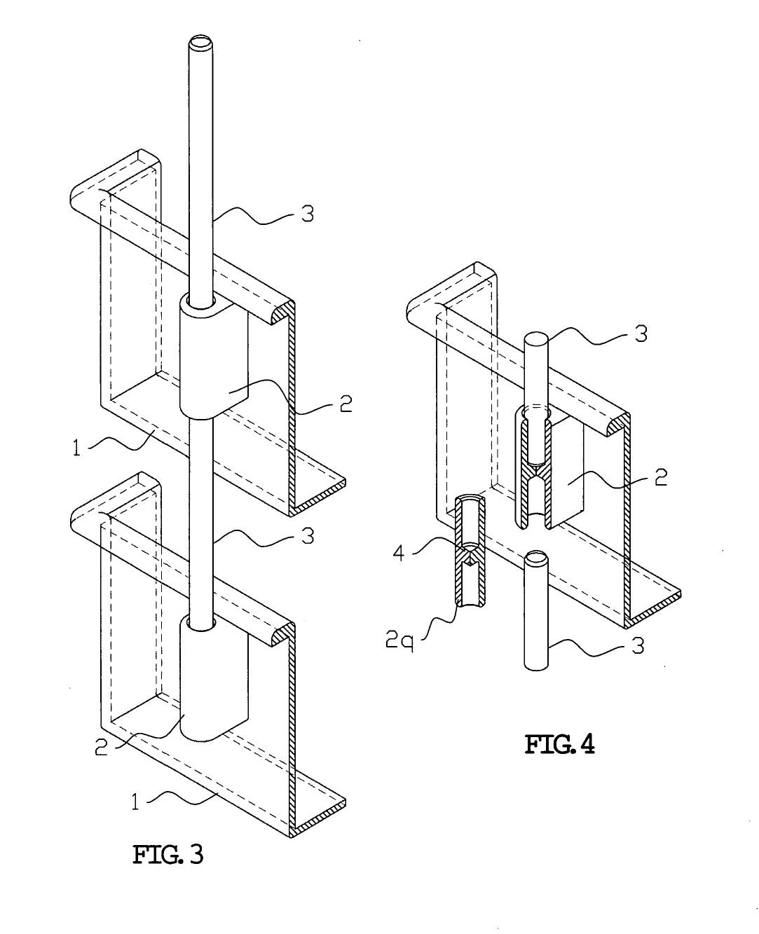

The device comprises a plurality of bushings (2), externally shown on FIGS. 1, 2, and 3, which bushings 2 are outwardly coupled to the sidewalls of each tray 1, so that each of the trays 1 is furnished with an equal number of the bushings 2. The bushings 2 are essentially identically disposed at corresponding predetermined points of the sidewalls of each tray 1.

As illustrated on FIG. 4, showing a sectional quarter (2q) of the bushing 2, the bushing 2 is divided into an upper cavity and a lower cavity, both having a cylindrical shape. The dividing is provided by a flat circular partition (4) fixed in the middle of the bushing interior. Therefore, the upper cavity is formed with the inner sidewalls of the bushing 2 upward from the partition 4, whereas, the lower cavity is formed with the inner sidewalls of the bushing 2 downward from the partition 4.

The inventive device, shown on FIGS. 1, 2, 3, 4, 6, 7, 8, and 9, comprises cylindrical rods (3) removably snug-fitting into the cavities of the bushings 2. The rods 3 are made identical, so that any rod can be used in place of another rod. The rods 3 should be made with a predetermined height, allowing easy access to the cells 1′ contained in the trays 1.

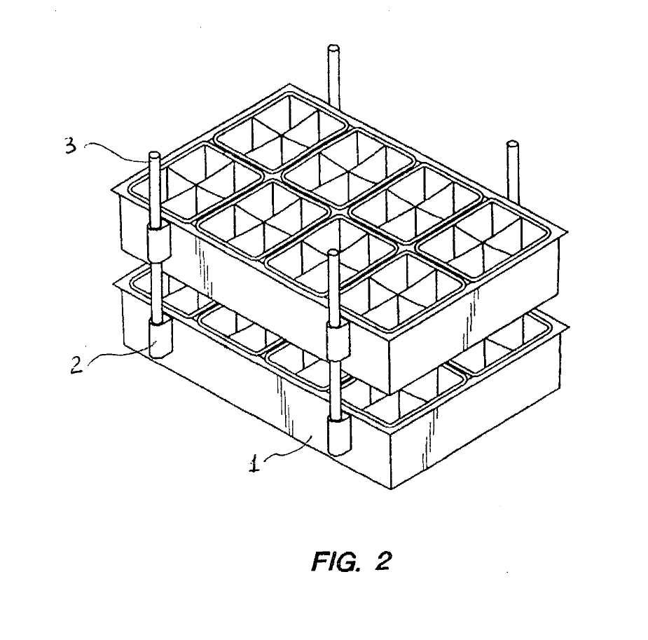

FIG. 2 depicts the same embodiment of the device in an assembled state, wherein a first tray 1 is stacked above a second tray 1. The bushings 2 and the rods 3 are also reflected on FIG. 2. As seen from FIGS. 1 and 2, the device is easy operated: the bottom ends of rods 3 are inserted in the upper cavities of bushings 2 of the lower tray 1, so that the rods 3 are supported by the partitions 4 of the bushings 2. Then the lower cavities of corresponding bushings 2 of the upper tray 1 are put on the tops of the rods 3, and therefore the upper tray is supported by the rods 3, which rods 3 are supported by the lower tray's bushing partitions (i.e. by the lower tray itself) that results in assembling the device.

Any suitable materials, such as light metals, metal-substitutes, plastics, etc. can be used for making aforesaid elements of the inventive device. The elements can be molded, punched, or otherwise produced.

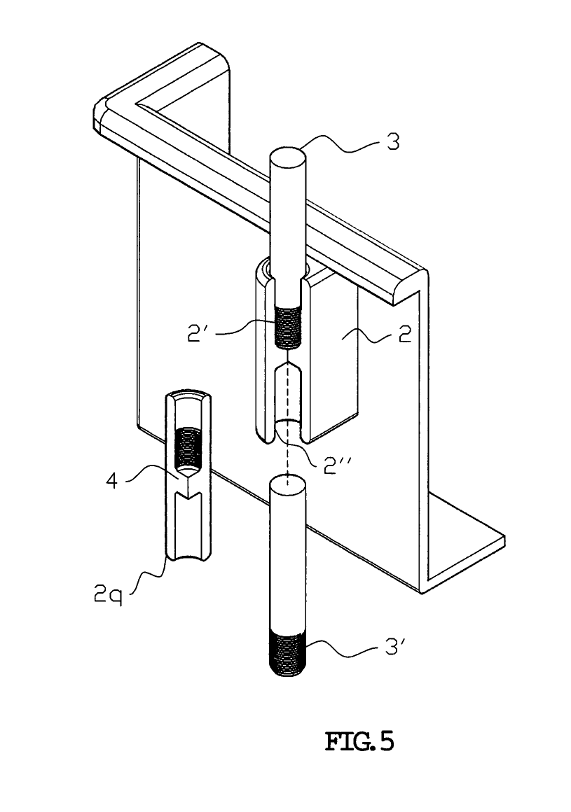

In some embodiments, the upper and lower cavities of the bushings 2 can be made different. For example, FIG. 5 illustrates a bushing 2 having an upper cavity (2′) and a lower cavity (2″), divided by a partition 4. The upper cavity 2′ includes a female screw threading, cut on the inner surface of the cavity. The rod 3 includes a male screw threading (3′), cut on the lower portion of side surface of the rod.

In such embodiments, the rods are removably coupled by the threading to the upper cavities of the bushings of a lower tray in the stack, that reduces the risk of their falling out and losing. This kind of rods 3 should be considered when the trays need often moving and transporting.

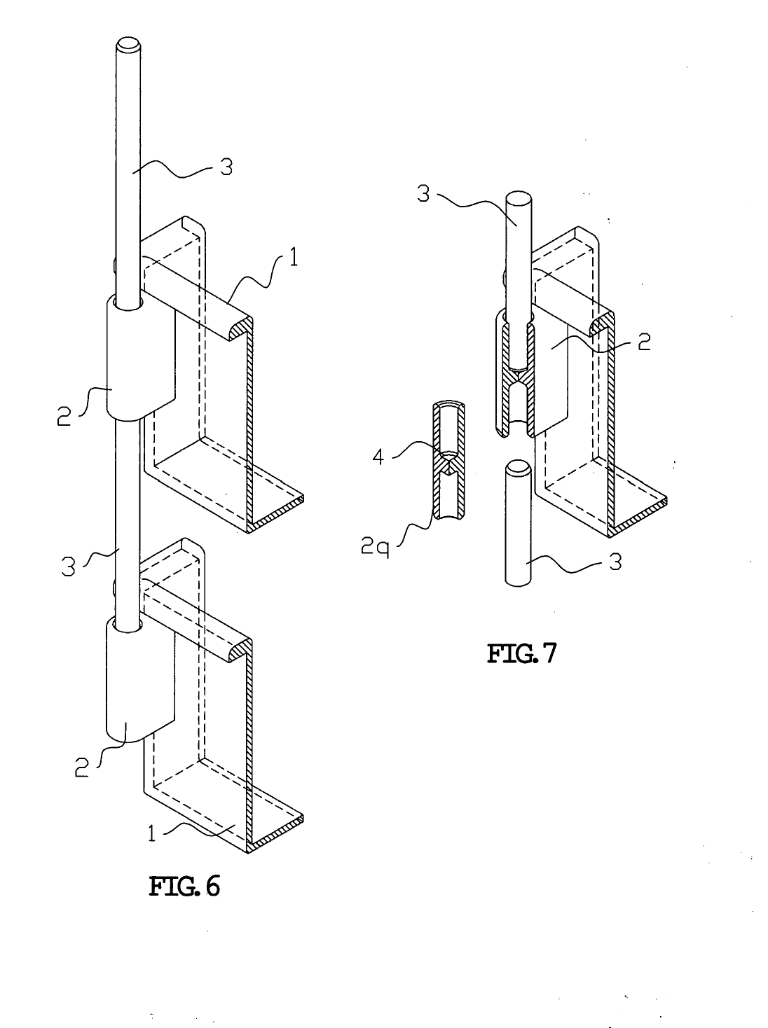

According to another embodiment, illustrated on FIGS. 6 and 7, the bushings 2 are attached to the trays 1, connected by the rods 3, wherein the bushings 2 are disposed on the tray's sidewall close to each corner of the tray.

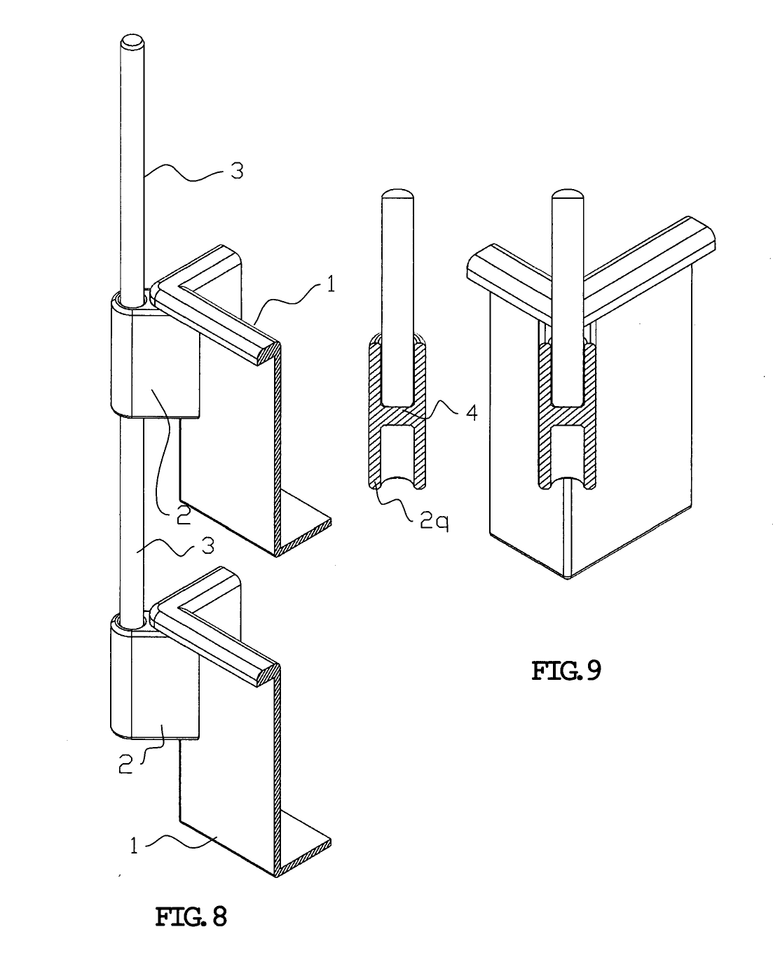

A similar embodiment, illustrated on FIGS. 8 and 9, the bushings 2 are attached to the trays 1, connected by the rod 3, wherein the bushings 2 are disposed on the tray's sidewall at each corner of the tray. These embodiments should provide higher rigidity of the tray's structure, useful for trays with heavy cells.

Since plants in the cells will grow, two or more sets of rods 3 might be needed, wherein each set has rods of a predetermined height, so that the rods of a first set will have a minimal height, the rods of a second set will, for example, have an incrementally greater height, etc. This enables using the set consisting of rods, whose height better corresponds to the current height of the plants.

Further embodiments (not illustrated) may have component rods of an identical height, each including a top hole with a female screw threading, and a bottom head with a male screw threading. Two or more such rods can be joined by means of the threadings in one combined rod. The lower end of the combined rod with the bottom head can then be coupled to an upper female-threaded cavity of the bushing (similar to the cavity 2′ on FIG. 5). Thusly, this embodiment enables the component rods to be assembled with each other, and enables the bottom head of the lowest component rod of the assembled combined rod to be coupled to the upper cavity of the bushing. In this way, the height of the combined rods can be conveniently incremented while the plants in the cells are growing.

It will be understood that each of the elements described above, or two or more together, may also find a useful application in other types of constructions and methods differing from the types described above.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

I claim

1. A plant nursery device comprising
at least two essentially identical trays containing plant cells;
a plurality of essentially identical bushings, each said bushing coupled to one of said at least two trays, so that each of said at least two trays furnished with an equal number of said bushings essentially identically disposed at corresponding predetermined points of the trays, each said bushing internally including an upper cavity and a lower cavity, and a partition fixed between said upper cavity and said lower cavity; and
a plurality of essentially identical rods of predetermined heights insertable into said upper and lower cavities;
wherein said at least two trays capable to be assembled in stack by making at least one of said trays a lower tray, inserting the rods into the upper cavities of the bushings of said lower tray, inserting the rods into the lower cavities of the corresponding bushings of another tray of said trays, thereby making it an upper tray.

2. The plant nursery device according to claim 1, wherein
each said tray including a bottom and vertical sidewalls fixed to the bottom, and
said bushings coupled to the sidewalls of each said tray.

3. The plant nursery device according to claim 2, wherein
each said tray being shaped as a rectangular parallelepiped without the topside.

4. The plant nursery device according to claim 3, wherein
the bushings disposed on the sidewalls at or close to each corner of the tray.

5. The plant nursery device according to claim 1, wherein
said upper cavity of each said bushing including a female screw threading, cut on its inner surface, and
each said rod including a male screw threading, cut on the lower portion of its side surface, thereby enabling the rods to be removably coupled by the threading to the upper cavities of the bushings of the lower tray in the stack.

6. The plant nursery device according to claim 1, wherein
said plurality of rods including at least two sets of rods, a first of said at least two sets consisting of rods of a predetermined minimum height, the rest of said at least two sets each consisting of rods of a predetermined height incrementally greater than the predetermined minimum height, enabling to use the set of rods whose height better corresponding to the current height of the plants.

7. The plant nursery device according to claim 1, wherein
said upper cavity of each said bushing including a female screw threading, cut on its inner surface; and
each of said plurality of rods performed as a combined rod, assembled of at least two component rods having an identical height;
wherein each said component rod including a top hole with a female screw threading and a bottom head with a male screw threading, thereby enabling said component rods to be assembled with each other, and enabling the bottom head of the lowest component rod of the assembled combined rod to be coupled to said upper cavity, allowing to incrementally change the height of the combined rods corresponding to the current height of the plants.
